(19) United States
(12) Patent Application Publication
(10) Pub. No.: US 2021/0061078 A1
(43) Pub. Date: Mar. 4, 2021

(54) BED COVER OF PICKUP TRUCK THAT IS EASY TO DISASSEMBLE AND ASSEMBLE

(71) Applicant: WENZHOU CHAOMING AUTO PARTS LTD, WENZHOU (CN)

(72) Inventors: LANHUA CAI, WENZHOU (CN); YI LIN, WENZHOU (CN)

(73) Assignee: WENZHOU CHAOMING AUTO PARTS LTD

(21) Appl. No.: 16/584,876

(22) Filed: Sep. 26, 2019

(30) Foreign Application Priority Data
Aug. 28, 2019 (CN) 201910799205.3

(51) Int. Cl. B60J 7/14

(52) U.S. Cl. CPC B60J 7/141

(57) ABSTRACT

This invention is relevant to a bed cover of pickup truck that is easy to disassemble and assemble. The bed cover of pickup truck includes one bed cover. The invention is based on the mutual cooperation of two aircraft buckles structure and uses hooks of bolts to clamp the side wall of the bed cover. The users can tighten the first handle or the second handle to realize the opposite unlocking. The aircraft buckles structure can be opened and it will be convenient to install and disassemble the bed cover. The position of bed cover of pickup truck can be adjusted easily.

### CROSS-REFERENCE TO RELATED APPLICATIONS

This application claims priority to Chinese Patent Application No. 201910799205.3 with a filing date of Aug. 28, 2019. The content of the aforementioned applications, including any intervening amendments thereto, are incorporated herein by reference.

### TECHNICAL FIELD

This invention is relevant to mechanical field, especially about the bed cover of pickup truck.

### BACKGROUND TECHNOLOGY

Pickup truck is a car with cab and an open truck compartment. The disadvantage of existing bed cover of pickup truck is that water will seep into the inside of the rotating shaft in the transfer part. Thus it will result in the need for additional waterproof strips in the transfer part. The installation of waterproof strips is complex and the stability is poor. When water seeps into the inside of the rotating shaft, all the water in the rotating shaft can not be leaked due to the position of the outlet hole on the socket. And the installation hole on the socket destroys the overall makes the bed cover not so beautiful. At the same time, when the existing bed cover is opened or closed, it is not easy to disassemble, assemble and adjust, which will make customers uncomfortable when using it.

### ABOUT THE INVENTION

The purpose of the invention is to provide a bed cover of pickup truck that is easy to disassemble and assemble and solve at least one technical problem above.

Thus the invention use the following method:

A bed cover of pickup truck that is easy to disassemble and assemble includes one bed cover, wherein said bed cover includes at least two cover plates; the adjacent cover plates are connected by rotating shaft device;

the rotating shaft device includes a plate-like pedestal, two turning parts which form a rotary connection with the pedestal;

there is a first rotating part on both sides of the pedestal, the lower surface of which is cambered; there is a rotary groove whose cross section is major arc shape in the above part of the first rotary part; and there exists the first blocking blade in the inner rotary groove which is close to the turning parts;

one side of the turning parts is connected with the cover plates, and there is the first groove which matches with the first rotating part in the another side of the turning parts; and there is the second blocking blade which is hook shape in the above part of the first groove; and there is the front part of the second blocking blade in the rotary groove.

A first groove is arranged on the lower surface of one of the two turning parts. And the first strip groove is provided with two aircraft buckle structures which are the first aircraft buckle structure and second aircraft buckle structure. They are respectively arranged on both sides of the first strip groove.

The first aircraft buckle structure comprises the first bolt, the first positioning block, the first connecting block, the second connecting block, the first wire rope and the first compression spring. The first bolt includes the first hook with a bending shape. The first bolt is fixed on the first wire rope. There is the first positioning block on one side of the first bolt. The first positioning block is fixed to the turning parts through a bolt. The first positioning block is provided with a first through-hole for passing through the first wire rope. One side of the first positioning block is provided with the first connecting block. The first connecting block is fixed to the first wire rope, and one side of the first connecting block is provided with the second connecting block. The second connecting block is provided with a second through-hole for passing through the first wire rope. The first connecting block and the second connecting block are all provided with a first sheet-shaped plate which acts as the first handle. The first compression spring is arranged between the first bolt and the first positioning block. And spring is sleeved on the outer side of the first wire rope.

The second aircraft buckle structure comprises the second bolt, the second positioning block, the third connecting block, the fourth connecting block, the second wire rope and the second compression spring. The second bolt includes the second hook with a bending shape. The second bolt is fixed on the second wire rope. There is the second positioning block on one side of the second bolt. The second positioning block is fixed to the turning parts through a bolt. The second positioning block is provided with a third through-hole for passing through the second wire rope. One side of the second positioning block is provided with the third connecting block. The third connecting block is fixed to the second wire rope, and one side of the third connecting block is provided with the fourth connecting block. The third connecting block is provided with a fourth through-hole for passing through the second wire rope. The third connecting block and the fourth connecting block are all provided with a second sheet-shaped plate which acts as the second handle. The second compression spring is arranged between the second bolt and the second positioning block. And spring is sleeved on the outer side of the second wire rope.

The second connecting block is fixed to the second wire rope, and the fourth connecting block is fixed to the first wire rope.

Both sides of the first bolt, the first connecting block, the second connecting block, the second bolt, the third connecting block and the fourth connecting block are provided with a ladder-like groove. The upper part of the two sides of the strip groove is provided with a third sheet-shaped plate for the limitation.

The bed cover comprises two mounting rods for fixing to the two sides of the bed cover of the pickup truck. The mounting rod is equipped with a strip convex for locking the first or second hook. The length direction of the strip convex is the same as that of the mounting rod.

A mounting block is arranged on the lower surface of the cover plate. And a second groove is arranged in the middle of the mounting block. The transversely arranged cylinder is arranged in the second groove.

A second strip groove is arranged on one side of the mounting rod and the second strip groove is used as the first chute. The first chute is provided with a first slide block and a second slide block. The first slide block is provided with a ball-end connecting rod, the ball-end of the ball-end connecting rod is embedded in a ball-end connector. And the ball-end connector is connected with one side of the supporting rod. The other side of the support rod is provided with a first slot for clamping the cylinder, and the second slide block is provided with a second slot for clamping the support rod.

The cross sections of the first slot and the second slot are major arc shape. The second chute is arranged on the lower surface of the cover plate. The mounting block is arranged in the second chute.

One side of the turning parts is provided with the first embedded slot; and the one side of the cover plate is embedded into the slot;

A sidebar is set in the outside part of the cover plates to protect the side of the cover plates; and there is the second embedded slot for the cover plates set in one side of the sidebar.

There is a corner socket set in the corner of the cover plates to connect the adjacent sidebars; The two ends of the corner socket are provided with a first plug for inserting into the first insert slot.

a rotating shaft socket set in outside part of the rotating shaft device to protect the device; the rotating shaft socket contains one first socket installed in the outside part of the pedestal and two second sockets installed in the outside part of the turning parts;

there is the second rotating part on both sides of the first socket; and the lower surface of the second rotating part is arc-shaped; the upper side of the second rotating part is provided with a drainage channel connected with the rotating groove;

one side of the second socket is fixedly connected with the sidebar; and the another side of the second socket is provided with a third groove matching the shape of the second rotating part; the second rotating part is arranged in the third groove.

With an opening on one side of the third groove as a drainage port, the width of the third groove is less than that of the second socket.

The upper part of the first socket is provided with the fourth sheet-shaped plate to cover the pedestal and the upper part of the second socket is provided with the fifth sheet-shaped plate to cover the turning parts.

The second plug for inserting into the first insert slot is arranged on one side of the second socket, and then one side of the second socket is fixedly connected with the side bar.

A second insert slot is arranged on the pedestal and the turning parts. And a third plug for inserting the second insert slot is arranged on the upper part of the first and second socket. A first thread bolt hole is arranged on the pedestal and the turning parts. A second thread bolt hole matching the position of the first thread bolt hole is arranged on the first and the second socket. Then the pedestal is fixed with the first socket, the turning parts and the second socket by thread bolts.

When the rotating shaft device is used, the second blocking blade rotates in the rotating slot. When turned to the maximum angle, the second blocking blade will be blocked by the first blocking blade and its further rotation will be restricted. The turning parts can rotate from 0° to 95° opposite the pedestal, while the two adjacent cover plates can rotate 0° to 190° opposite to each other. The rotating range is large. It is very convenient to open the bedcover of the pickup truck when used. The drainage channel in the invention are bigger and will not cause syphonage. Thus the leading function will be better, requirement of the assembly accuracy will be lower and the production will be easier.

When the aircraft buckle structure is in use, the user can tighten the first handle or the second handle to realize the opposite unlocking. Namely, the first or second sheet-shaped plate is tightened so that the first connecting block and the second connecting block, or the third connecting block and the fourth connecting block are close to each other. Thus the first or second bolt is pulled inward, thereby opening the aircraft buckle structure and make it convenient to disassemble and assemble the bed cover; Taking the first aircraft buckle structure as an example, when the first bolt moves inward, it will squeeze the compression spring. Then the other end of the compression spring holds the first positioning block, thus forming an elastic expansion of the first bolt. Similarly, the second bolt of the second aircraft buckle structure also forms elastic expansion.

This invention provides a bed cover of pickup truck that is easy to disassemble and assemble with simple structure and great leading function. At the same time, the invention is based on the mutual cooperation of two aircraft buckles structure and uses hooks of bolts to clamp the side wall of the bed cover. The users can tighten the first handle or the second handle to realize the opposite unlocking. Thus, the aircraft buckles structure can be opened and it will be convenient to install and disassemble the bed cover of pickup truck. The position of bed cover of pickup truck can be adjusted easily and the user experience can be improved.

### DESCRIPTION OF DRAWINGS

FIG. 1 is an illustration of the state of use in the invention;

FIG. 2 is a front view of the state of use in the invention;

FIG. 3 is a partial structure illustration in the invention.

FIG. 4 is a partial structure side view in the invention.

FIG. 5 is a cross-sectional illustration of a partial structure in the invention.

FIG. 6 is an illustration of partial structural cross section at the turning parts in the invention.

FIG. 7 is an illustration of partial structural cross section of the pedestal in the invention.

FIG. 8 is an illustration of partial structural cross-section after the combination of the pedestal and turning parts in the invention.

FIG. 9 is a partial structural illustration of the first strip groove in the invention.

FIG. 10 is a partial structural illustration of the aircraft buckle structure in the invention.

FIG. 11 is a bottom view illustration of the partial structure in the invention.

FIG. 12 is a decomposition illustration at the rotary shaft joint in the invention.

FIG. 13 is a bottom view at the joint of the rotating shaft in the invention.

### THE CONCRETE METHOD TO CARRY OUT

The following instruction is to further explain the concrete implementation method of the invention.

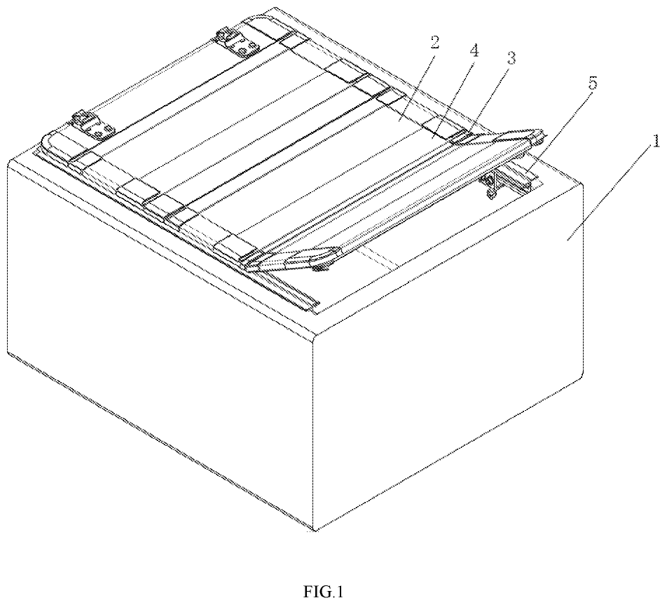

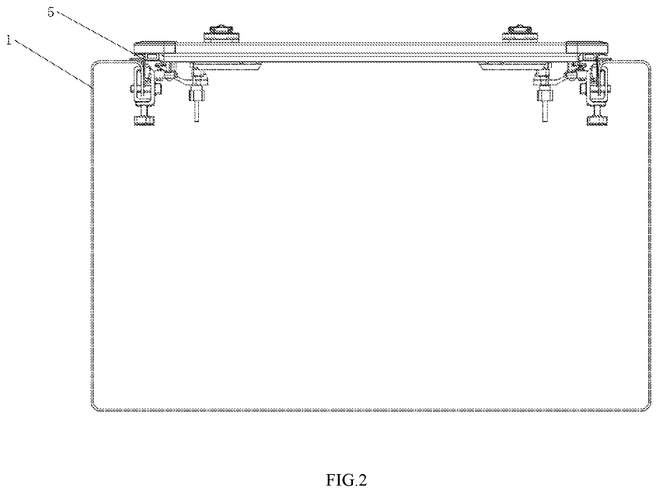

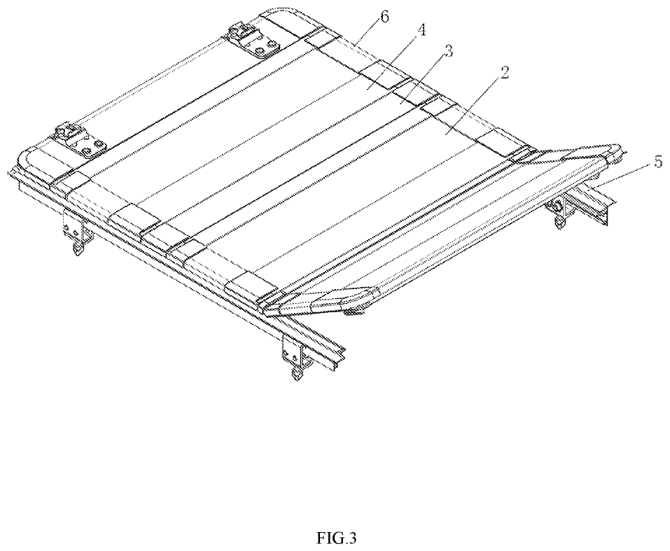

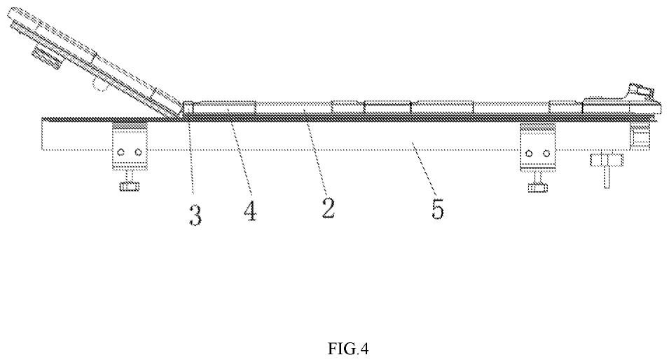

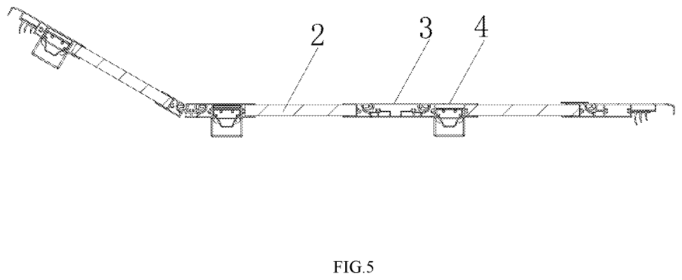

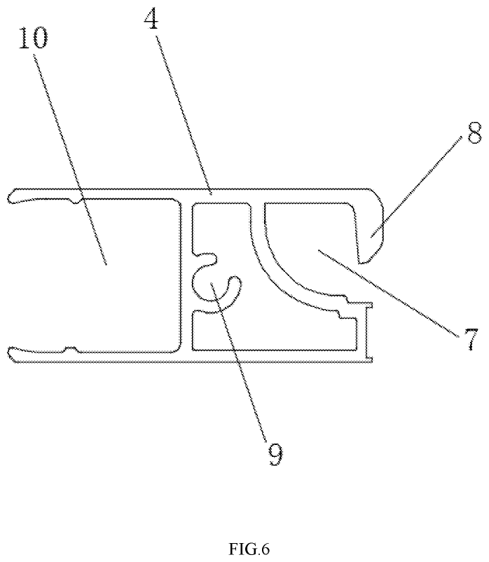

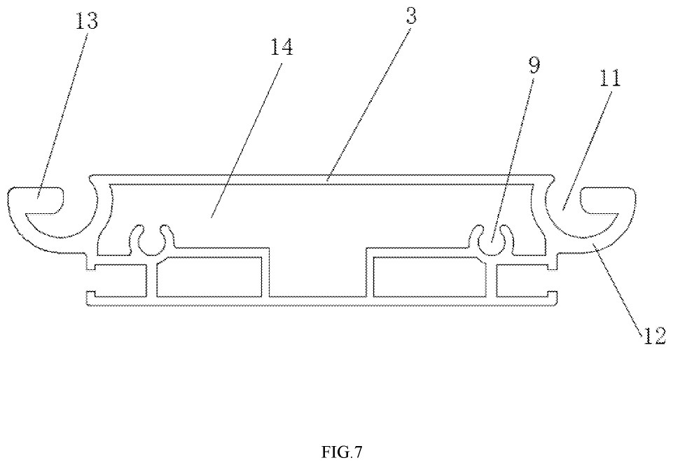

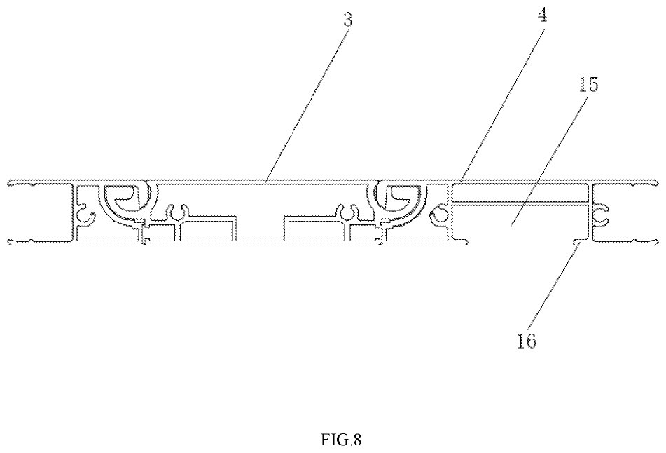

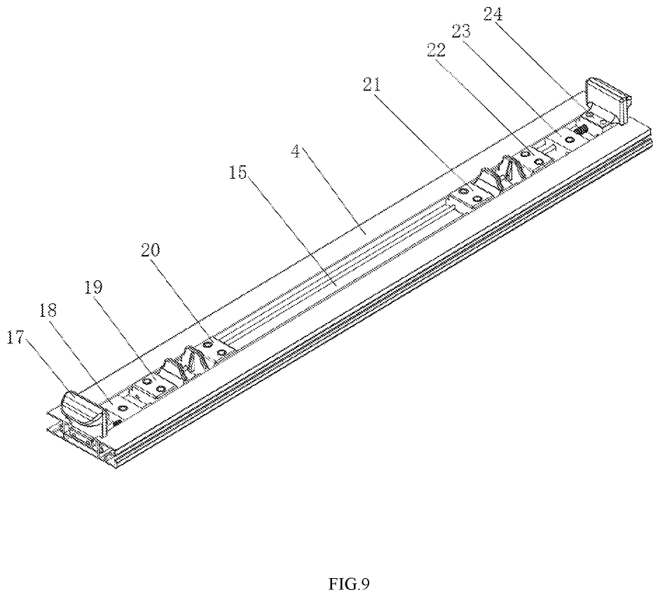

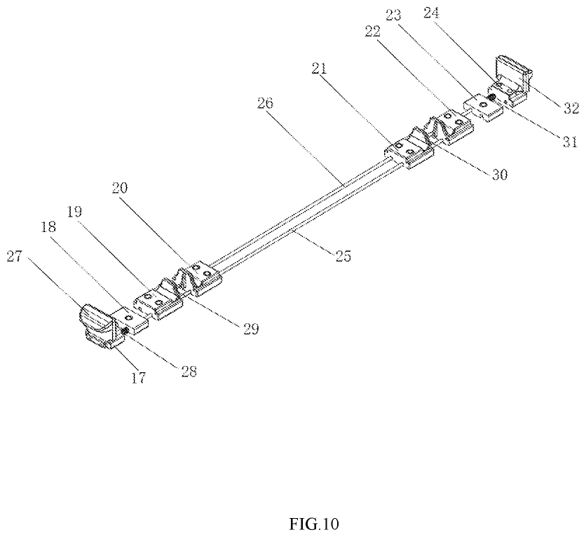

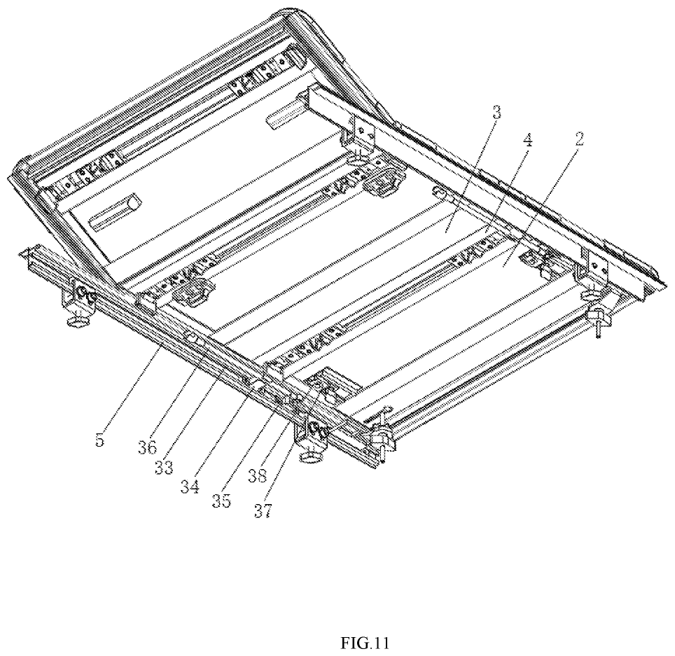

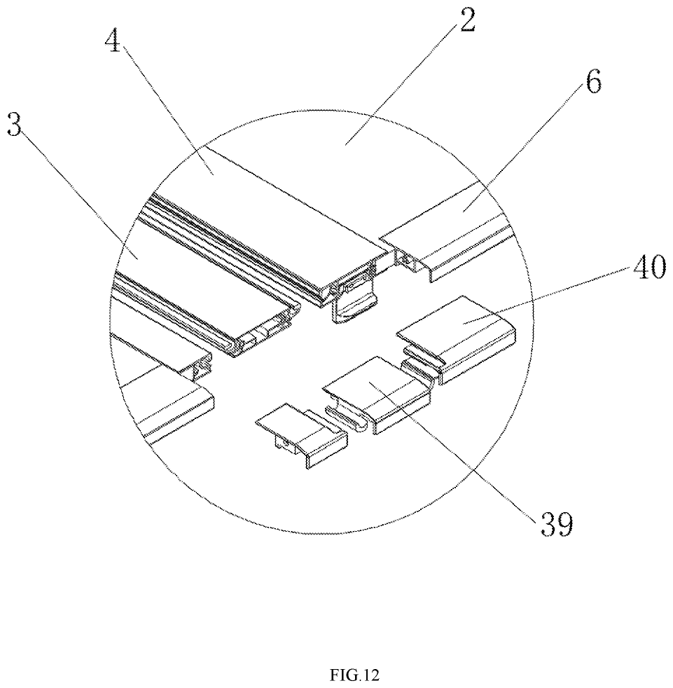

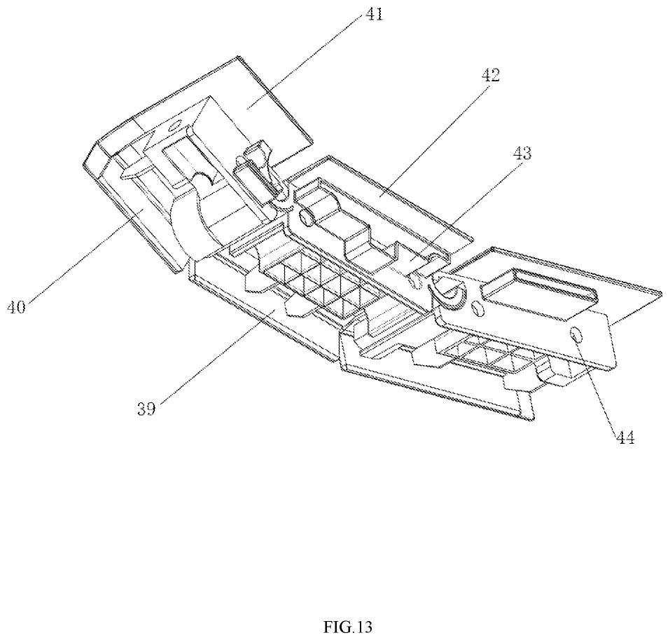

As is seen from FIGS. 1 to 13, a bed cover of pickup truck that is easy to disassemble and assemble includes one bed cover, wherein said bed cover includes at least two cover plates 2; the adjacent cover plates are connected by rotating shaft device; the rotating shaft device includes a plate-like pedestal 3, two turning parts 4 which form a rotary connection with the pedestal; there is a first rotating part 12 on both sides of the pedestal, the lower surface of which is cambered; there is a rotary groove 11 whose cross section is major arc shape in the above part of the first rotary part; and there exists the first blocking blade 13 in the inner rotary groove which is close to the turning parts; one side of the turning parts is connected with the cover plates, and there is the first groove 7 which matches with the first rotating part in the another side of the turning parts; and there is the second blocking blade 8 which is hook shape in the above part of the first groove; and there is the front part of the second blocking blade in the rotary groove. A first groove 15 is arranged on the lower surface of one of the two turning parts. And the first strip groove is provided with two aircraft buckle structures which are the first aircraft buckle structure and second aircraft buckle structure. They are respectively arranged on both sides of the first strip groove. The first aircraft buckle structure comprises the first bolt 17, the first positioning block 18, the first connecting block 19, the second connecting block 20, the first wire rope 25 and the first compression spring 28. The first bolt includes the first hook 27 with a bending shape. The first bolt is fixed on the first wire rope. There is the first positioning block on one side of the first bolt. The first positioning block is fixed to the turning parts through a bolt. The first positioning block is provided with a first through-hole for passing through the first wire rope. One side of the first positioning block is provided with the first connecting block. The first connecting block is fixed to the first wire rope, and one side of the first connecting block is provided with the second connecting block. The second connecting block is provided with a second through-hole for passing through the first wire rope. The first connecting block and the second connecting block are all provided with a first sheet-shaped plate 29 which acts as the first handle. The first compression spring is arranged between the first bolt and the first positioning block. And spring is sleeved on the outer side of the first wire rope. The second aircraft buckle structure comprises the second bolt 24, the second positioning block 23, the third connecting block 22, the fourth connecting block 21, the second wire rope 26 and the second compression spring 31. The second bolt includes the second hook 32 with a bending shape. The second bolt is fixed on the second wire rope. There is the second positioning block on one side of the second bolt. The second positioning block is fixed to the turning parts through a bolt. The second positioning block is provided with a third through-hole for passing through the second wire rope. One side of the second positioning block is provided with the third connecting block. The third connecting block is fixed to the second wire rope, and one side of the third connecting block is provided with the fourth connecting block. The third connecting block is provided with a fourth through-hole for passing through the second wire rope. The third connecting block and the fourth connecting block are all provided with a second sheet-shaped plate 30 which acts as the second handle. The second compression spring is arranged between the second bolt and the second positioning block. And spring is sleeved on the outer side of the second wire rope. The second connecting block is fixed to the second wire rope, and the fourth connecting block is fixed to the first wire rope. This invention provides a bed cover of pickup truck that is easy to disassemble and assemble with simple structure and great leading function. At the same time, the invention is based on the mutual cooperation of two aircraft buckles structure and uses hooks of bolts to clamp the side wall of the bed cover. The users can tighten the first handle or the second handle to realize the opposite unlocking.

Thus, the aircraft buckles structure can be opened and it will be convenient to install and disassemble the bed cover of pickup truck. The position of bed cover of pickup truck can be adjusted easily and the user experience can be improved.

When the rotating shaft device is used, the second blocking blade rotates in the rotating slot. When turned to the maximum angle, the second blocking blade will be blocked by the first blocking blade and its further rotation will be restricted. The turning parts can rotate from 0° to 95° opposite the pedestal, while the two adjacent cover plates can rotate 0° to 190° opposite to each other. The rotating range is large. It is very convenient to open the bedcover of the pickup truck when used. The drainage channel in the invention are bigger and will not cause syphonage. Thus the leading function will be better, requirement of the assembly accuracy will be lower and the production will be easier.

When the aircraft buckle structure is in use, the user can tighten the first handle or the second handle to realize the opposite unlocking. Namely, the first or second sheet-shaped plate is tightened so that the first connecting block and the second connecting block, or the third connecting block and the fourth connecting block are close to each other. Thus the first or second bolt is pulled inward, thereby opening the aircraft buckle structure and make it convenient to disassemble and assemble the bed cover; Taking the first aircraft buckle structure as an example, when the first bolt moves inward, it will squeeze the compression spring. Then the other end of the compression spring holds the first positioning block, thus forming an elastic expansion of the first bolt. Similarly, the second bolt of the second aircraft buckle structure also forms elastic expansion.

In order to facilitate installation or maintenance, the first bolt, the first connecting block and the fourth connecting block are all provided with a fifth through-hole and a first bolt hole for passing through the first wire rope. The first bolt hole is connected with the fifth through-hole. Then the first bolt, the first connecting block and the fourth connecting block are fixed to the first wire rope by screwing the bolt into the fifth through-hole and compressing the first wire rope. Similarly, the second bolt, the third connecting block and the second connecting block are all provided with a sixth through-hole and a second bolt hole for passing through the second wire rope. The second bolt hole is connected with the sixth through-hole. Then the second bolt, the third connecting block and the second connecting block are fixed to the second wire rope by screwing the bolt into the sixth through-hole and compressing the second wire rope.

Both sides of the first bolt, the first connecting block, the second connecting block, the second bolt, the third connecting block and the fourth connecting block are provided with a ladder-like groove. The upper part of the two sides of the strip groove is provided with a third sheet-shaped plate 16 for the limitation. The third sheet-shaped plate holds against the groove, and then confines the first bolt, the first connecting block, the second connecting block, the second bolt, the third connecting block and the fourth connecting block to move in the first strip groove.

The bed cover comprises two mounting rods 5 which are fixed to the side walls of the bed cover of pickup truck by the bolts respectively. The mounting rod is equipped with a strip convex for locking the first or second hook. The length direction of the strip convex is the same as that of the mounting rod. There are many types of pickup trucks. For example, when the side wall of the container is too thick to be clamped by the bolt, you can clamp the mounting rods on both sides of the bed cover by the first and the second bolt respectively to fix bed cover of the pickup truck through the first or second bolt. And it will increase the connection strength between the bed cover of the pickup truck and the pickup truck.

A mounting block 37 is arranged on the lower surface of the cover plate. And a second groove is arranged in the middle of the mounting block. The transversely arranged cylinder 38 is arranged in the second groove. A second strip groove 33 is arranged on one side of the mounting rod and the second strip groove is used as the first chute. The first chute is provided with a first slide block 35 and a second slide block 34. The first slide block is provided with a ball-end connecting rod, the ball-end of the ball-end connecting rod is embedded in a ball-end connector. And the ball-end connector is connected with one side of the supporting rod 36. The other side of the support rod is provided with a first slot for clamping the cylinder, and the second slide block is provided with a second slot for clamping the support rod. The cross sections of the first slot and the second slot are major arc shape. The second chute is arranged on the lower surface of the cover plate. The mounting block is arranged in the second chute. The ball-end connecting rod matching with the ball-end connector can facilitate the rotation of the support rod. When the user opens the bed cover, the cylinder will be clamped into the first slot of the support rod by rotating the support rod. And the overturned cover plate can be supported by the support rod. When you need to take in the support rod, rotate the support rod and clamp the support rod into the second slot to make the support rod parallel to the installation rod. The first slide block in the first chute, the second chute and the mounting block are matched to facilitate adjusting the angle of opening the container cover. At the same time, the support rod plays a better supporting role for the overturned cover plate.

At least two of the cover plates are made of FRP Honeycomb Panel. The rotating shaft device is made of plastic. The pedestal adopts hollow structure to reduce the cost and make it easier to produce.

In order to ensure the structural strength of the equipment, the pedestal and the first rotating part, the first rotating part and the first blocking blade all adopt the integrated structure. And the turning parts and the second blocking blade adopt the integrated structure. The bottom surface of the first groove is arc-shaped to match the lower surface of the first rotating part, which is more smooth when deflected.

One side of the turning parts are provided with the first embedded slot. 10 And the one side of the cover plate is embedded into the slot. So the turning parts are fixedly connected with the cover plates. The cross section of the first embedded slot is ⊏ shape. And the first embedded slot is provided with at least two opposite first strip convex. The length direction of first convex is the same as that of the connector.

The sidebar 6 is set in the outside part of the cover plates to protect the side of the cover plates. And there is the second embedded slot for the cover plates set in one side of the sidebar. The first insert slot is arranged on both ends of the sidebars. The cross section of the second embedded slot is in the shape of ⊏. The second embedded slot is provided with at least two opposite arranged second strip convex. And the length direction of the second strip convex is the same as the length direction of the sidebar. The sidebars are used to protect the sides of the cover plates and reduce the damage caused by collision on the side edges of the cover plates.

There is a corner socket set in the corner of the plates to connect the adjacent sidebars. The two ends of the corner socket are provided with a first plug for inserting into the first insert slot to connect the sidebars and enhance the installation strength of the sidebar. Using the cover plate located on the outer side of the bed cover as an example, the first sidebar is arranged on the left side of the cover plate, the second sidebar is arranged on the front side of the cover plate. And the third sidebar is arranged on the right side of the cover plate. Thus the first sidebar will be connected with the second sidebar through the first corner socket, and the second sidebar will be connected with the third sidebar through the second corner socket.

There is a rotating shaft socket set in outside part of the rotating shaft device to protect the device. The rotating shaft socket contains one first socket 39 installed in the outside part of the pedestal and two second socket 40 installed in the outside parts of the turning parts; there is the second rotating part on both sides of the first socket. And the lower surface of the second rotating part is arc-shaped. The upper side of the second rotating part is provided with a drainage channel connected with the rotating groove; one side of the second socket is fixedly connected with the sidebar. And the another side of the second socket is provided with a third groove matching the shape of the second rotating part. The second rotating part is arranged in the third groove. The water seeping into the rotating groove will flow into the drainage channel and quickly flow through the drainage channel. Thus The invention has better drainage performance. The bottom surface of the third groove is arc-shaped to match the lower surface of the second rotating part. And the second rotating part is more smooth when deflected. With an opening on one side of the third groove as a drainage port, the width of the third groove is less than that of the second socket. The drainage outlet is then arranged on the inner side of the second socket. The drainage outlet which is with hidden faun is arranged inside the second socket to avoid additional opening of water outlet and guarantee the overall beauty of the cover. A waterproof gasket is arranged below the first socket and the second socket and an opening is arranged on the waterproof gasket located below the drainage outlet.

The upper part of the first socket is provided with the fourth sheet-shaped plate 42 to cover the pedestal. And the upper part of the second socket is provided with the fifth sheet-shaped plate 41 to cover the turning parts. The fourth sheet-shaped plate and the first socket, the fifth sheet-shaped plate and the second socket all adopt the integrated structure. The outer part of the cover plate and the rotating shaft device is covered by the sheet-shaped plate and the side bar thus achieving the waterproof effect.

The second insert slot 14 is arranged on the pedestal and the turning part. And a second plug 43 for inserting the second insert slot is arranged on the upper part of the first and second socket. A first thread bolt hole 9 is arranged on the pedestal and the turning part. A second thread bolt hole 44 matching the position of the first thread bolt hole is arranged on the first and the second socket. Then the pedestal is fixed with the first socket, the turning part and the second socket by thread bolts. The first socket and the pedestal, the second socket and the connector are fixedly connected through plug insertion and bolt screw. Thus they are closely connected, achieve sealing and waterproof effect.

Finally, it should be noted that the above is only a preferred embodiment of the invention and is not used to limit the invention. Although the invention is described in detail with reference to the above embodiment, it is still possible for those skilled in the field to modify. Or they can do equivalent replacement of some of the technical features in it. Any modification, equivalent replacement, improvement etc. made within the spirit and principles of the invention shall be included in the scope of protection of the invention.

We claim:

1. A bed cover of pickup truck that is easy to disassemble and assemble, wherein said bed cover of pickup truck includes one bed cover, the bed cover includes at least two cover plates; the adjacent cover plates are connected by rotating shaft device;
the rotating shaft device includes a plate-like pedestal, two turning parts which form a rotary connection with the pedestal;
there is a first rotating part on both sides of the pedestal, the lower surface of which is cambered; there is a rotary groove whose cross section is major arc shape in the above part of the first rotary part; and there exists the first blocking blade in the inner rotary groove which is close to the turning parts;
one side of the turning parts is connected with the cover plates, and there is the first groove which matches with the first rotating part in the another side of the turning parts; and there is the second blocking blade which is hook shape in the above part of the first groove; and there is the front part of the second blocking blade in the rotary groove;
a first groove is arranged on the lower surface of one of the two turning parts; and the first strip groove is provided with two aircraft buckle structures which are the first aircraft buckle structure and second aircraft buckle structure; they are respectively arranged on both sides of the first strip groove;
the first aircraft buckle structure comprises the first bolt, the first positioning block, the first connecting block, the second connecting block, the first wire rope and the first compression spring; the first bolt includes the first hook with a bending shape; the first bolt is fixed on the first wire rope; there is the first positioning block on one side of the first bolt; the first positioning block is fixed to the turning parts through a bolt; the first positioning block is provided with a first through-hole for passing through the first wire rope; one side of the first positioning block is provided with the first connecting block; the first connecting block is fixed to the first wire rope, and one side of the first connecting block is provided with the second connecting block; the second connecting block is provided with a second through-hole for passing through the first wire rope; the first connecting block and the second connecting block are all provided with a first sheet-shaped plate which acts as the first handle; the first compression spring is arranged between the first bolt and the first positioning block; and spring is sleeved on the outer side of the first wire rope;
the second aircraft buckle structure comprises the second bolt, the second positioning block, the third connecting block, the fourth connecting block, the second wire rope and the second compression spring; the second bolt includes the second hook with a bending shape; the second bolt is fixed on the second wire rope; there is the second positioning block on one side of the second bolt; the second positioning block is fixed to the turning parts through a bolt; the second positioning block is provided with a third through-hole for passing through the second wire rope; one side of the second positioning block is provided with the third connecting block; the third connecting block is fixed to the second wire rope, and one side of the third connecting block is provided with the fourth connecting block; the third connecting block is provided with a fourth through-hole for passing through the second wire rope; the third connecting block and the fourth connecting block are all provided with a second sheet-shaped plate which acts as the second handle; the second compression spring is arranged between the second bolt and the second positioning block; and spring is sleeved on the outer side of the second wire rope;
the second connecting block is fixed to the second wire rope, and the fourth connecting block is fixed to the first wire rope.

2. The bed cover of pickup truck that is easy to disassemble and assemble according to claim 1, wherein said bed cover comprises two mounting rods for fixing to the two sides of the bed cover of the pickup truck; the mounting rod is equipped with a strip convex for locking the first or second hook; the length direction of the strip convex is the same as that of the mounting rod.

3. The bed cover of pickup truck that is easy to disassemble and assemble according to claim 2, wherein said mounting block is arranged on the lower surface of the cover plate; and a second groove is arranged in the middle of the mounting block; the transversely arranged cylinder is arranged in the second groove;
a second strip groove is arranged on one side of the mounting rod and the second strip groove is used as the first chute; the first chute is provided with a first slide block and a second slide block; the first slide block is provided with a ball-end connecting rod, the ball-end of the ball-end connecting rod is embedded in a ball-end connector; and the ball-end connector is connected with one side of the supporting rod; the other side of the support rod is provided with a first slot for clamping the cylinder, and the second slide block is provided with a second slot for clamping the support rod;
the cross sections of the first slot and the second slot are major arc shape.

4. The bed cover of pickup truck that is easy to disassemble and assemble according to claim 1, wherein said second chute is arranged on the lower surface of the cover plate, and the mounting block is arranged in the second chute.

5. The bed cover of pickup truck that is easy to disassemble and assemble according to claim 1, wherein said both sides of the first bolt, the first connecting block, the second connecting block, the second bolt, the third connecting block and the fourth connecting block are provided with a ladder-like groove; the upper part of the two sides of the strip groove is provided with a third sheet-shaped plate for the limitation.

6. The bed cover of pickup truck that is easy to disassemble and assemble according to claim 1, wherein said one side of the turning parts is provided with the first embedded slot; and the one side of the cover plate is embedded into the slot.

7. The bed cover of pickup truck according to claim 1, wherein a sidebar is set in the outside part of the cover plates to protect the side of the cover plates; and there is the second embedded slot for the cover plates set in, one side of the sidebar.

8. The bed cover of pickup truck that is easy to disassemble and assemble according to claim 7, wherein there is a corner socket set in the corner of the cover plates to connect the adjacent sidebars.

9. The bed cover of pickup truck that is easy to disassemble and assemble according to claim 8, wherein there is a rotating shaft socket set in outside part of the rotating shaft device to protect the device; the rotating shaft socket contains one first socket installed in the outside part of the pedestal and two second sockets installed in the outside part of the turning parts;
there is the second rotating part on both sides of the first socket; and the lower surface of the second rotating part is arc-shaped; the upper side of the second rotating part is provided with a drainage channel connected with the rotating groove;
one side of the second socket is fixedly connected with the sidebar; and the another side of the second socket is provided with a third groove matching the shape of the second rotating part; the second rotating part is arranged in the third groove.

10. The bed cover of pickup truck that is easy to disassemble and assemble according to claim 9, wherein the upper part of the first socket is provided with the fourth sheet-shaped plate to cover the pedestal; and the upper part of the second socket is provided with the fifth sheet-shaped plate to cover the turning parts.
